(19) United States
(12) Patent Application Publication
(10) Pub. No.: US 2006/0257609 A1
(43) Pub. Date: Nov. 16, 2006

(54) Cascading color display device

(76) Inventor: Steven B. Winter, Highland Park, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/128,998

(22) Filed: May 13, 2005

(51) Int. Cl. B32B 9/00; B32B 37/12; B32B 38/04

(52) U.S. Cl. 428/40.1; 156/289; 156/264

(57) ABSTRACT

This invention is directed to a painted color sample display device for the comparative illustration of paint color. The invention also is directed to a method for making such a color display device. The color card or display device of the invention displays a plurality of paint colors with color swatch layers which partially overly each other. The plurality of paint coated color swatch layers are in stacked overlapping relation. A top swatch layer partially overlies a first immediate swatch layer below the top layer swatch. The first intermediate layer overlies a second intermediate layer below the first intermediate layer. Each of the layers are hingedly joined at the top and do not completely cover the painted swatch layer below. This permits the viewer to view the paint color on each of the swatch layers.

### FIELD OF THE INVENTION

The present invention relates to color sample display devices for paint products. More particularly, the present invention is directed to color sample display devices which have one or more colored paint swatches which are removable from a mount base and are in overlying cascading relation to each other.

### BACKGROUND OF THE INVENTION

A problem exists in the display of color such as paint colors wherein a color display card often displays a plurality of colors with a plurality of color chips or swatches on a mount base or display card. Often the viewer desires to view and compare colors and/or tones in side by side relation as well as view a color remote from the card without the distraction of the display product and/or other colors on the card. Heretofore, color or paint swatch display devices have not been able to perform both functions: presenting colors in side by side overlapping relation and providing paint swatches removable from a base and remountable remote from the base. Prior to the invention herein, adhesives and mounting system would permit removal of relatively small paint color chips, but (1) would not attractively hold the swatches, especially relatively large swatches, onto the mount base, or (2) would provide a bond so weak that there was a likelihood that the color chips would be unintentionally lost from the mount base and card, or (3) would not permit side by side viewing coupled with alternative remote mounting and viewing of the paint swatch.

Color display devices need to display the color on the chips or swatches attractively. They can not be wrinkled and curled, but when mounted on a base a swatch and its associated base must lay flat. Ideally when displayed remote from the device the swatch should be large enough for the viewer to readily evaluate and appreciate from a distance. The larger the swatch and associated base, the more prone the combination is to curling. Further, if the large swatches are to illustrate color comparatively, ideally the swatches will not only overlap each other, but at the same time have the ability to be viewed alone. Illustration of the swatches in overlapping relation also is deleteriously affected by curling of the individual swatches. Finally, to provide a display device with removable chips or swatches, the device must have swatches which not only are removable, but which may be removed without rendering the card unattractive because the swatches are ripped or torn or having layers of the mount base removed with the removal of the adhesively affixed swatch.

An object of this invention is to provide a color display device with a plurality of relatively large paint coated colored swatches which comparatively displays a plurality of colors to a buyer at a point of purchase where the swatches are adhesively affixed to a base, but which may be removed and displayed remotely from the base by adhesively affixing the swatch to an alternate substrate.

Another object of the invention is to provide a color display device with a plurality of swatches in stacked, overlapping and cascading relation with removable paint coated swatches.

Another object of the invention is to provide a color display device which displays relatively large paint coated swatches in overlapping relation which can be viewed together or alone when part of the device.

Yet another object of the invention is to provide a color display device with overlapping paint coated swatches which resist curl and wrinkling.

A further object of the invention is to provide a method for making a color display device having a plurality of swatches in stacked overlapping relation which swatches are removed for display remote from the device.

These and other objects will become more apparent with reference to the description set forth below.

### SUMMARY

This invention is directed to a painted color sample display device for the comparative illustration of paint color. The invention also is directed to a method for making such a color display device. The color card or display device of the invention displays a plurality of paint colors with color swatch layers which partially overly each other. The plurality of paint coated color swatch layers are in stacked overlapping relation. A top swatch layer partially overlies a first immediate swatch layer below the top layer swatch. The first intermediate layer overlies a second intermediate layer below the first intermediate layer. Each of the layers are hingedly joined at the top and do not completely cover the painted swatch layer below. This permits the viewer to view the paint color on each of the swatch layers. Each of the entire swatch layers may be viewed in their entirety by pivotally rotating the overlying top layer(s) away from the bottom layer immediately below. Each of the swatch layers include a base paper layer, a printed release composition layer, a pressure sensitive adhesive layer and a removable paint coated swatch. The base paper layer comprises at least 80 pound cover paper both sides of which have been calendared. The removable paint coated swatch is releasably mounted on the base layer with an indirect pressure sensitive adhesive. The indirect pressure sensitive adhesive bonds the removable paint coated swatch to the base, but also provides a releasably bonded paint coated color swatch which may be repositioned remote from the color display device and releasably bonded onto a remote substrate. The color display device with repositionable painted swatches provides swatches which may be remounted onto furniture, walls, other samples and fabrics to aid the consumer of the color to select the color on the swatch and match it with other colors and the environment for which the color is intend.

The swatch layers of the color card or sample display device include a base, a printed release composition on the mount base, a printed indirect pressure sensitive adhesive on the printed release composition layer, and a painted color swatch for the illustration of color. The pressure sensitive indirect adhesive, which releasably binds the painted swatch to the printed release composition on the mount base, has about 0.8 to about 3.0 oz. per inch bond strength using a 180 degree peel adhesion test after about a 24 hour dwell time and a minimum of about 250 grams of wet tack bond strength contact placement within about 30 seconds or less.

The color swatch includes sized paper which is coated with paint, and in an important aspect, the color substrate may be a polymeric film such as polypropylene film or polyethylene terephthalate film, commonly sold under the name of Mylar. These polymeric films are less likely to rip as compared to paper and have a thickness in the range of from about 1.35 to about 4.6 mils, and preferably, from about 1.6 to about 2.6 mils. The use and application of paint to the base is important for the precise color matching of the swatch color with the color of the article which the swatch is to illustrate.

When the polymer films are thin, such as when the films have a thickness of from about 1.35 to about 1.6 mils, a paper tissue or thin paper reinforcing agent is adhesively affixed to the film forming a film/paper laminate. The film/paper laminate is releasably affixed to the release composition with the indirect pressure sensitive adhesive.

The method of the invention includes applying paint to a large web substrate, such as a paper or polymeric film, with a knife coater or roller-roller coater as is known. The painted web is cut to size to create the paint coated swatches which are mounted onto the swatch layer via the release composition and indirect adhesive. The base for the swatch layers is made by printing a release composition on to a paper base. When required the release composition, such as a silicone release composition, is cured with heat or light such as UV light. The paper must be at least an eighty (80) pound cover paper with both sides of the paper calendered. Thereafter a pressure sensitive indirect adhesive is printed onto the printed release composition on the paper base. Printing the release agent onto the base is important because it prescisely positions the area where the repositionable swatch is placed in what results in a descending placement of the removable painted coated swatches on the base relative to the top of the base of the swatch layer. Precise descending placement of the release adhesive layers on the swatch layer base is important to keeping the paint coated removable swatch the same size throughout the device. As the swatch layers and paint coated swatches thereon are viewed in descending order down the overlapping layers, the position of a removable paint coated swatch will change and be down farther from the top edge of the base of the swatch layer relative to the overlying removable paint coated swatches, as the lower removable swatches are viewed.

After the printed application of the release layer and indirect pressure sensitive adhesive on the paper base, the painted swatches are applied to the indirect adhesive on the paper base. The release composition and adhesive layers may be printed onto the mount base by lithographic printing, Gravure printing, flexographic printing and silk screen printing. In an important aspect, the release composition layer and the pressure sensitive indirect adhesive are printed onto their respective base layers by a flexographic printing process. The release composition is flexographically printed onto the base and then the pressure sensitive indirect adhesive is flexographically printed on the dried release composition layer. The color swatches then may be mounted onto the printed adhesive on the mount base using a till box, as is known in the art, or a high speed mounting machine as described in U.S. Pat. No. 4,061,521 to Lemer. Indeed, printing the indirect adhesive onto the release composition is highly adaptable with such a high speed machine.

The individual swatches are die cut and then joined and collated in a Diddle Glaser collator with one color per station to collate each swatch layer in the cascading color display device. After the swatch layers are collated in cascading relation, the layers are fed onto an elongated vibrating table that is downward inclined such that the collated layers will slide down the incline so that the top edges of the layer will hit a stop as the table vibrated. The vibrating table has slots such that pushers or dogs push the collated layers to sticker or binder (such as a staple). The combination of the top edges of the layers hitting the stop and the pushers pushing the side edges of the layers during vibration of the table, precisely registers the top and side edges of the layers in stacked relation. After the latter registration of the edges of the layers, the layers at the top of the device are bound.

In another aspect of the invention, the removable paint coated swatch is divided into two areas or portions by a tear line. The tear line which divides the swatch into at least two portions, a first portion which is affixed to the base with a printed permanent adhesive printed on the base and a second portion is releasably affixed to the indirect pressure sensitive releasable adhesive printed on the release composition. The tear line provides a releasably bonded paint coated color swatch from the second portion of the swatch which is repositionable remote from the color display device and releasably bonded onto a remote substrate. This second portion of the swatch is releasably affixed to the base by the indirect adhesive which is bonded to the printed release composition. The first portion of the swatch is permanently affixed to the base by the printed permanent adhesive and provides a means for providing the viewer a record of the colors and painted coated swatches removed from the color display device. Again printing the release layer, the indirect adhesive and the permanent adhesive is important to positioning the portions of the swatch so the releasable portion of the swatch can be cleanly removed from the base without the tearing of the removable portion because of misplacement of the permanent adhesive.

### DETAILED DESCRIPTION

Definitions

“Indirect adhesive” means a pressure sensitive adhesive which releasably binds an object to a substrate base. An indirect adhesive is applied to a base to which the object is mounted and when the object is removed from the base, the indirect adhesive will transfer to or move to the object and the object will retain adhesive which will permit the object to be adhesively mounted to another base. Further, the indirect adhesive should be capable of being printed. Suitable indirect adhesives include but are not limited to acrylic emulsion polymers which are commercially available as Aroset 2538 and 2539 from Ashland Chemical Company, and microsphere acrylic polymers which are commercially available as 271 Series Adhesive Gel-Tac Acrylic Polymers from Advanced Polymers International.

A “releasable adhesive” is an indirect or direct adhesive which releasably bonds an object to a substrate.

“Permanent adhesive” means an adhesive which does not releasably affix an object to a substrate, but rather permanently affixes the object to the substrate. Suitable permanent adhesives include a copolymer of polyvinyl acetate commercially available as Crodafix 57-066 from Croda Adhesives, Inc., Itasca, Ill., and Resyn (R) 33-9245, available from National Starch Company. The permanent adhesive should be printable.

“Release composition” means a composition which is coated onto a release liner or on an object to be adhesively affixed to an indirect or direct adhesive to facilitate the removal of the object which is adhesively affixed to a base with the indirect or direct adhesive. Suitable release compositions include but are not limited to a wax and varnish blend which is suitable to release an object affixed with Aroset adhesives; a free radical UV silicone release composition commercially available from Croda Adhesives, Inc., as Croda 30-19-3; a cationic UV silicone release composition commercially available from Croda Adhesives as Croda 30-24-1; a two component thermoset release composition commercially available as Croda 24-26-2 parts 1 and 2; and conventional commercially available silicone release compositions. The Croda and conventional silicone release compositions are suitable for use with the Aroset indirect adhesive and the 271 indirect adhesives from Advanced Polymers International

### DESCRIPTION OF THE DRAWINGS

FIG. 1 is a top view of a color display device

FIG. 2 is the side view of the color display device of FIG. 1.

FIG. 3 is a perspective view of the color display device of FIG. 1 with a top swatch layer being lifted and a removable swatch being peeled from the next lower layer.

FIG. 4A is a side view of the swatch layer which includes the removable paint coated swatch on the base.

FIG. 4B is a side view of an alternate type of swatch layer where the swatch is divided into portions divided by a tear line, one portion of the swatch affixed to the base with a permanent adhesive and one portion of the swatch affixed to a release composition on the base.

FIG. 5 is a top view of the penultimate swatch layer showing the position of the removable paint coated swatch on that layer as well as the position of the paint coated swatch on the bottom layer.

FIG. 6 is a perspective view of a collator.

FIG. 7 is a front view of a vibrating table at the downstream end of the collator.

FIG. 8 is a side view of the vibrating table.

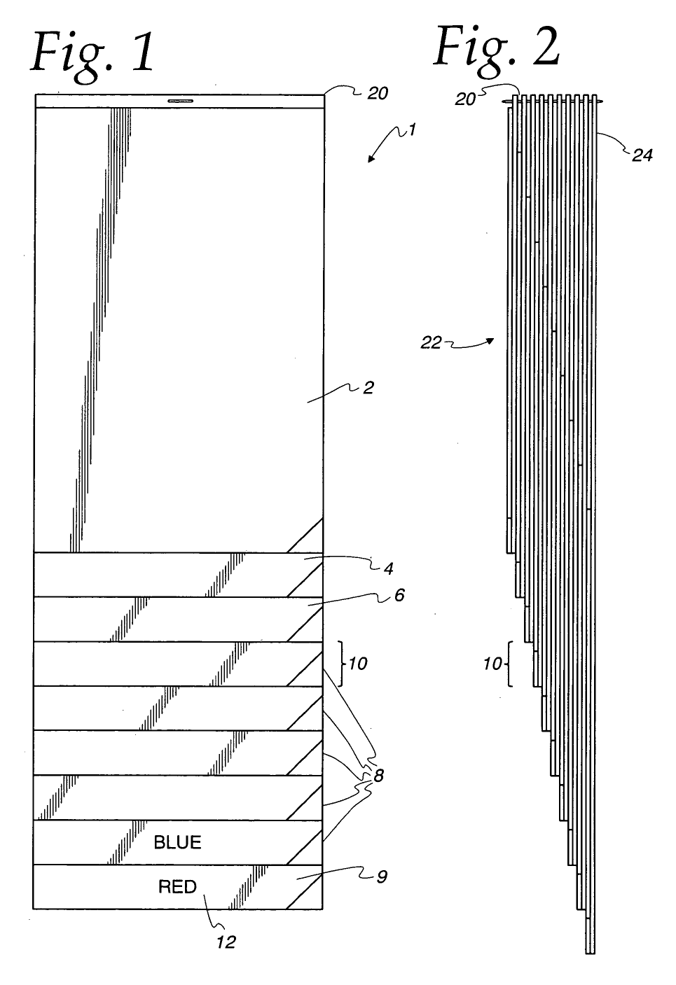

Referring to FIG. 1, a color display device 1 includes color swatch layers 2, 4 and 6. A top swatch layer 2 overlies a first intermediate layer 4, the first intermediate layer 4 overlies a second intermediate layer 6 which overlies additional intermediate layers 8 and bottom layer 9. Each swatch layer partially overlies the layer immediately below and is offset from the swatch layer immediately below by a distance 10. Each of the swatch layers are held together at the top 20 of the device by a fastener, spiral, permanent adhesive, staple(s) or the like. At the bottom of the offset stacked layers 22 is a base 24 (see FIG. 2) which may be a heavy sheet of paper to enhance the durability and stiffness of the device.

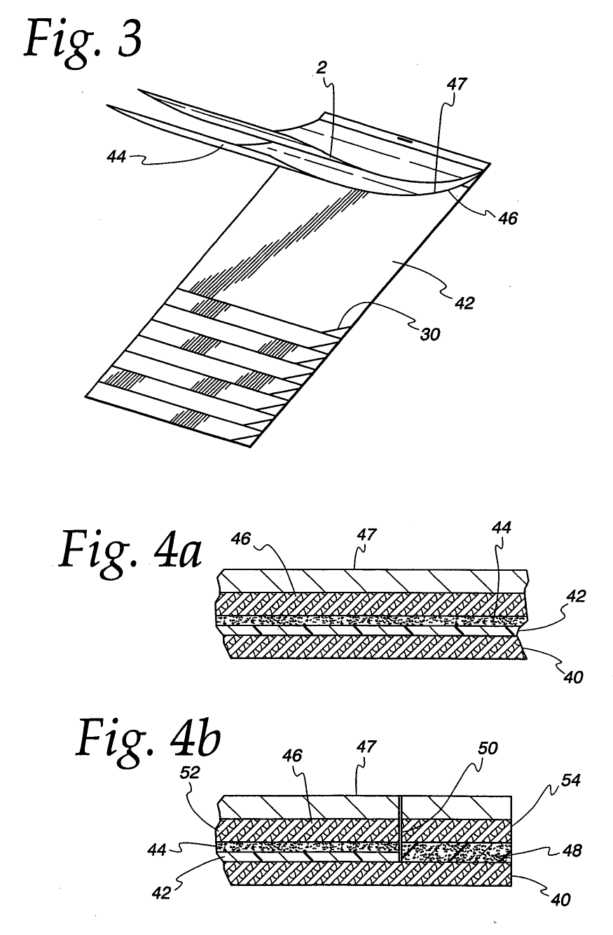

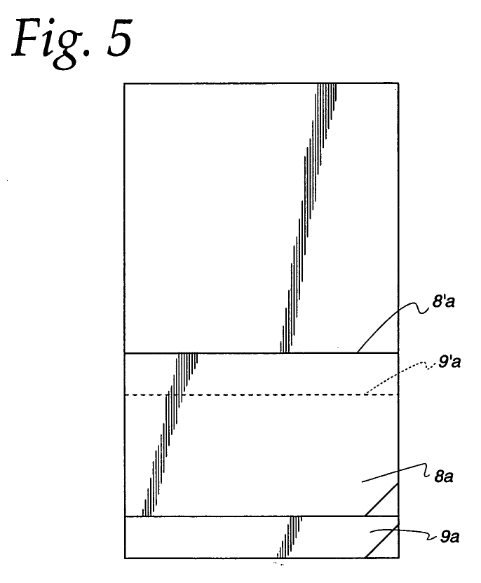

As seen if FIG. 4A, each swatch layer has a base layer 40, a printed release layer 42, a printed indirect adhesive layer 44 and a paint coated swatch which includes a swatch substrate 46 covered with a paint layer 47 on the top surface of the swatch substrate. As can be seen in FIG. 3, the swatch layers, such as layer 2, can be lifted up and away from one or more intermediate layers. The paint coated swatch substrate 46 may be peeled from the base layer 40 covered with release composition 42 with the adhesive layer 44 being transferred from the release layer 42 such that it is retained on the bottom of the swatch substrate. A die cut edge 30 facilitates release of the paint coated swatch from the release layer 42. The indirect adhesive transfers from the release composition 42 on the swatch layer to the underside of the painted swatch substrate. This transfer permits removal of the painted swatch substrate from the swatch layer to adhesively affix the painted swatch to a remote substrate for view and evaluation of a paint color in an environment where a consumer intends to use the paint.

The base layer 40 of the swatch layers must be at least an 80 pound cover paper with both sides of the paper being calendered. Eighty (80) pound cover paper means that 1000 sheets of 23 inch by 35 inch paper weigh 248 pounds. Lighter paper will curl and create an unattractive product, a problem which is especially acute with the relatively large removable paint coated swatches which are releaseably and adhesively affixed to the swatch layer base 40. Cost and product functionality effectively limit the weight of the base 40 of the swatch layers. Too heavy a base makes the color display product ineffective for providing large numbers of a thin display product with a plurality of stacked swatch layers. The product simply becomes too thick and costly as a give away at the point of purchase of the paint to which the device relates.

In an alternate embodiment as seen in FIG. 4B, the paint coated substrate 46 is divided into at least two portions with at least one tear line 50. The bottom portion 52 of the paint coated substrate or swatch is removable from the base at the tear line with a second portion of the swatch 54 being permanently affixed to the base with a permanent adhesive 48. Ideally, the second portion 54 of the swatch would be that portion of the swatch which can be viewed by virtue of the immediate overlying layer being offset and exposing the bottom edge of the swatch layer immediately below it. In other words, the portion of the swatch permanently affixed to the base is the exposed portion 10 as seen in FIG. 1 with the tear line being at or above the edge of the overlaying swatch layer, such as swatch layer 6.

The color display device permits the use of relatively large paint coated swatches which can be used to provide a realistic display of paint color remote from the device. Ideally the swatches will be 4 inches by 6 inches or even larger. As can be seen in FIG. 5, not only are the paint coated swatches offset from the bottom edge of the lower layer swatch, but the top edge of the upper layer paint coated swatch is offset above the top edge of the paint coated swatch immediately below. FIG. 5 serves as an example because it illustrates the relative positioning of the paint coated swatches 8a and 9a on the bottom two swatch layers of the color display device. Bottom swatch layer 9 and painted swatch 9a extend beyond the bottom edge of the painted swatch 8a on layer 8 and the top edge 8′a of painted swatch 8a is above the top edge 9′a of the painted swatch 9a on swatch layer 9. The offset relationships of the paint coated swatches permits each swatch to be of the same size and area. To maintain the offset relationships of the paint coated swatches requires precise placement of each paint coated swatch on the swatch layer. Printing of the release coating and the indirect adhesive (as well as the permanent adhesive in the embodiment shown in FIG. 4B) permits the precise placement of the swatch.

In an alternate embodiment, the swatch is made from an organo polymeric film such as acrylic coated polyproplylene or polyethylene terephthalate. Polyethlyene terephthalate is also known as Mylar which is a registered trademark of E.I. DuPont DeNemours & Co. The acrylic coated polypropylene and polyethylene terephthalate films provide a transparent film base which as a thickness in the range of from about 1.35 mils to about 4.60 mils (one mil is 0.001 inch). Paint is applied to the film. In one aspect the paint layer 47 is on the surface of the film facing the swatch substrate 46. Thinner polymeric films having a thickness in the range of from about 1.35 to about 1.6 mils are bonded or laminated onto thin paper or tissue paper to give them more body and make them easier to handle during the manufacture of the color display device. This paper or tissue provides a paper layer, which is bonded onto the adhesive layer 44. In this aspect of the invention using polymeric film as the swatch substrate, the adhesive layer is on a layer of release composition 42 which has been printed onto the base 40. In the aspect of the invention using polymeric film as the swatch substrate, the paint coating to be displayed is applied to the polymeric film swatch on the side of the film which will be facing the base 40. The swatch will be viewed from the side of the translucent film which is opposite to the side having the paint coating. (Hereinafter the “bottom side” of the polymeric film substrate). With thicker films the side of the polymeric base with the paint coating, or bottom side, will interface with the adhesive. With thinner films which are laminated with the paper tissue, the paper tissue will interface with the adhesive and the paint on the film will be observed through the film from the “top” of the film which is secured to the base 40 through the release composition 42, indirect adhesive 44, tissue and paint layers. In this aspect of the invention the translucency of the film may be utilized and the paint may be displayed with a high gloss finish because the swatch is affixed to the mount base with the unpainted polymeric surface of the swatch facing away from the base. The polymeric film thereby permits the display of the paint coating through the film; and hence, with a glossy finish without the problem of having the glossy surface fuse to an overlying surface, such as when the swatch layers are in stacked relation. In the art this fusing is commonly known as “blocking”.

Alternatively, the paint coating may be in the “top” surface of the film swatch substrate as seen in FIG. 4A. In this aspect the surface of the paint is viewed directly, and the film swatch substrate 46 is bonded onto the base 40 through the tissue paper, adhesive layer 44, and release composition layer 42.

To make the paint coated swatch, paper or polymeric film is painted with a paint coating composition to make the swatches which are removably affixed to the base. Generally, the paint coating composition is lacquer paint, but when polymeric films are used for the swatches, aqueous or latex paints may be applied to the film which permits reduction of volatile organic compound emissions. The coating of the paper or polymeric film may be by a knife over roll coating operation where a knife spreads the paint over the paper or film substrate as the substrate is conveyed under the knife by rollers as is known. The paint also may be applied by a roller-roller operation as is known. After the paper or film substrate is coated with paint, the paint coated paper or coated polymeric film is cut into strips and then swatches using a guillotine, as is known or the high speed mounting machine described herein. Thereafter, the cut swatches are applied to the base by means of the indirect adhesive printed on the mount base. This mounting may be done using a high speed mounting machine as is generally described in U.S. Pat. No. 4,061,521 to Lerner et al., assigned to Color Communications, Inc. This patent is incorporated by reference as if fully rewritten herein.

The method includes printing the release composition onto areas of the base 40 upon which the swatches will be mounted. As described above, printing permits precise control of the areas of the mount base to which the release composition is applied. The release composition which is printed onto the mount base is described in the definition section above. In an important aspect, the release composition used is a free radical UV silicone release composition such as Croda 30-19-3. The release composition layer provides a surface to which a releasable adhesive may bond, but the surface of the release composition is tough and will permit removal of the swatch without removing layers of paper from a base or tearing the base or chip with removal of the color swatch.

After the release composition layer is printed, cured and dried on the mount base, an indirect adhesive layer is printed onto the dried release composition layer. As with the release composition layer, the indirect adhesive layer may be printed onto the base by lithographic printing, Gravure printing, flexographic printing and silk screen printing. The printing process also permits precise control of the placement of the adhesive layer. Pressure sensitive adhesives such as an acrylic adhesive which are available as acrylic aqueous emulsions are ideal for use in the invention. As described above, indirect adhesives are available from the Ashland Chemical Company under the trademark AROSET, such as the AROSET 2528 acrylic emulsion polymer adhesive.

Referring to FIG. 1 the color of the swatches may be identified by printing 12 on the paint coated swatch in the area 10′ in the distance 10 which extends beyond the upper swatch layer. Indeed, in an important aspect, precise placement of the release composition and adhesive is important to the precise placement of the printing on the swatch. Misalignment the swatch will result in misplacement of the printing of identification indicia of the color on the swatch.

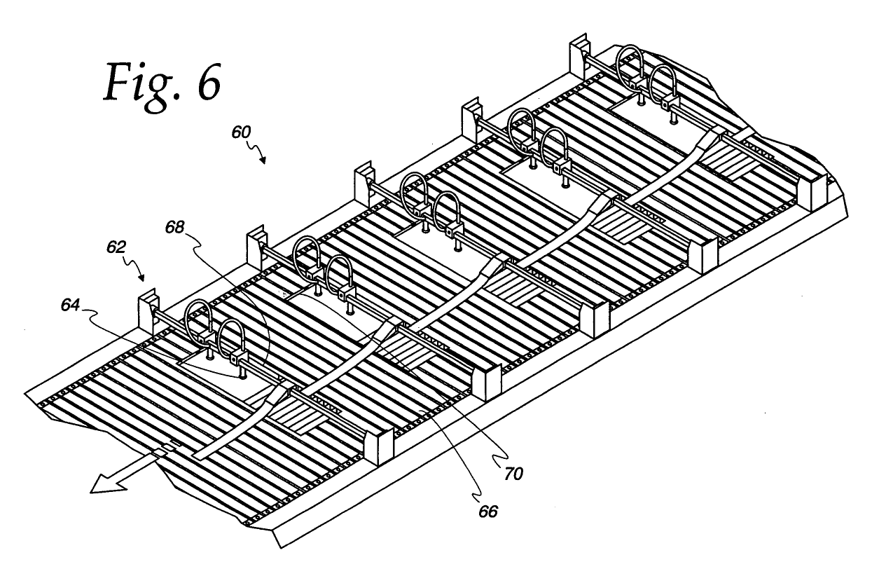

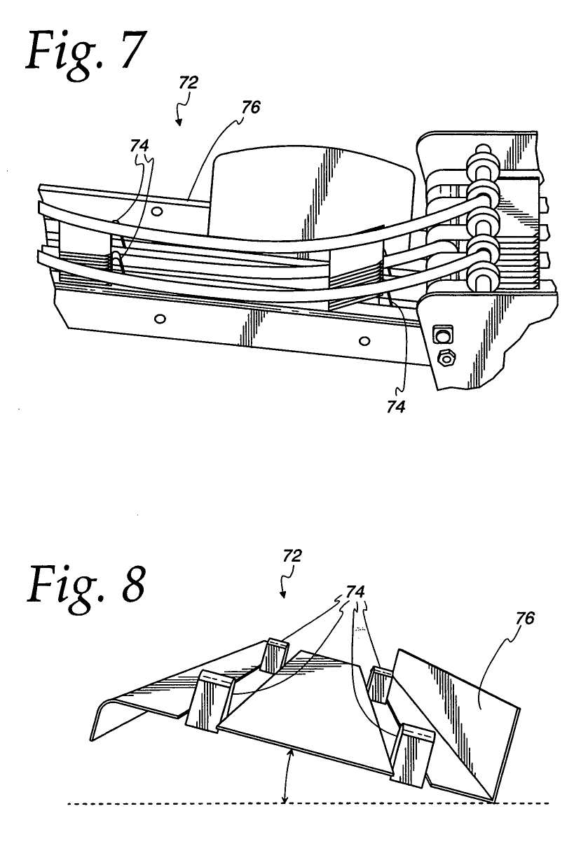

After the swatches are mounted onto the indirect adhesive layer on the base 40, the various layers are then collated with a Didde Glaser collator with one color per station as seen in FIGS. 6 and 7. The collator 60 lays each swatch layer at stations 62 such that each layer is offset from and partially overlies the layer immediately below. Vacuum suckers 64 lift each swatch from a bin below and lay it over another swatch as the stacked swatches move along a conveyor 66. This collator places the layers in position on top of the other, but upstream side edge 68 and top side edge 70 are not precisely aligned and form a single edge. Hence after the layers are stacked they are fed the stacked layers which make up one device onto a tilted inclined table 72.

As seen in FIG. 7, the surface of the table is inclined upwardly moving from the downstream to the upstream side of the production line. The stack of layers are pushed onto the elongated vibrating table 7 which has pushers which push the stacks at their upstream side edges which aligns the side edges of the layers as the pushers push the stacks of layers downstream to the binder. The surface of the vibrating table also is tilted so that the top edges of the layers side toward a top stop as the table vibrates and the pushers push the stacked layers downstream to a binding station not shown. The vibration coupled with the pushers pushing on the upstream edges of the stacks as well as the stacks sliding down the tilted table to stop 76 is effective for aligning the top and side edges of the switch layers for binding. After alignment of the top and side edges of the stacks of layers, each stack is bound at its top with a fastener such as a staple or glue or other type of binding.

The color display device of the invention provides at least two, but ideally a plurality of paint coated swatches which not only can be viewed at the same time at a point of purchase, but are removable from the swatch layer and are repositional to a remote substrate. After removal from the mount base, the indirect adhesive moves to the swatch such that the swatch may be removably adhesively affixed to an alternate substrate remote from the color display device. In this way the colored paint coated swatch may be removed from the display device and the colored or paint coated chip may be adhesively applied to a wall or furniture to permit the viewer to evaluate the color such as a paint color in the environment in which the color or paint is to be used.

What is claimed is:

1. A color display device which displays a plurality of colors with color swatches which partially overlie each other and overlap, the color display device comprising:
a plurality of paint coated color swatch layers in stacked relation, including a top swatch layer partially overlapping a first immediate swatch layer below the top layer, the first intermediate layer overlapping a second intermediate swatch layer below the first intermediate layer and a bottom swatch layer, each swatch layer having a bottom edge offset and above the layer immediately below so that each of the layers do not completely cover the swatch layer below and permitting a view or view paint on each of the swatch layers, the plurality of swatch layers joined at one end to permit the swatch layers to be lifted above and away from the intermediate layer immediately below, the swatch layers being joined so that the top and intermediate layers may be lifted so that the entire swatch layer below the swatch being lifted may be viewed,
each of the swatch layers including a base paper layer, a printed release composition layer, a printed pressure sensitive indirect adhesive layer and a removable paint coated swatch, the base paper layer comprising 80 pound cover paper both sides of which have been calendared, the removable paint coated swatch being releasably mounted on the pressure sensitive indirect adhesive, the pressure sensitive adhesive bonding to the paint coated swatch to the swatch layer and effective for providing a releasably bonded paint coated color swatch which may be repositioned remote from the color display device and releasably bonded onto a remote substrate.

2. The color display device of claim 1 wherein all of the swatch layers having at least one paint coated swatch adhesively affixed thereto, the top paint coated swatch on the top swatch layer and a paint coated swatch on an at least one intermediate swatch layer having bottom edges offset from and above the bottom edge of the paint coated swatch on the swatch layer immediately below thereby showing an area of the paint coated swatch, the paint coated swatches on the top paint coated swatch layer and the intermediate layers having a top edge which is above the top edge of the paint coated swatch on the swatch layer immediately below.

3. The color display device of claim 2 wherein the paint coated swatch includes a film substrate selected from the group consisting of a polypropylene and polyethylene terephthalate, the polypropylene film having a reinforcing tissue layer which overlays and is bonded to the pressure sensitive indirect adhesive layer.

4. The color display device of claim 2 wherein the paint coated chip layer comprises painted paper, the painted surface of the paper base layer having sizing layer interposed between the paper and the paint.

5. The color display device of claim 2 wherein the paint coated swatches have the same area.

6. A method for making a color display device, the method comprising:
printing a release composition on a paper base which comprises an 80 pound cover paper both sides of which have been calendared;
printing an indirect adhesive the printed release composition on the paper base;
applying a paint coated swatch to the printed indirect adhesive to provide a paint coated swatch layer;
cutting the paint coated swatch layers so that each layer has a different size; collating the paint coated swatch layers to provide a the color display device, the color display device having a plurality of paint coated color swatches layers each having a different size, the layers in stacked relation, a top layer partially overlapping a first immediate layer below the top layer, the first intermediate layer overlapping a second intermediate layer below the first intermediate layer, and a bottom layer each swatch layer having a bottom edge offset and above the layer immediately below so that each of the layers do not completely cover the swatch layer below permitting a viewer to view paint on each of the swatch layers, the plurality of swatch layers joined at one end to permit the swatch layers to be lifted above and away from the intermediate layer immediately below, the swatch layers being joined so that the top and intermediate layers may be lifted so that the entire swatch layer below the swatch being lifted may be viewed,
each of the swatch layers including the base paper layer, the printed release composition layer, the printed pressure sensitive indirect adhesive layer and the removable paint coated swatch, the removable paint coated swatch being releasably mounted on the pressure sensitive indirect adhesive, the pressure sensitive adhesive bonding to the paint coated swatch to the swatch layer and effective for providing a releasably bonded paint coated color swatch which may be repositioned remote from the color display device and releasably bonded onto a remote substrate.

7. The method of claim 6 wherein all of the swatch layers are printed with the release composition and indirect adhesive such that a top paint coated swatch on the top swatch layer and a paint coated swatch on the at least one intermediate swatch layer have bottom edges offset from and above the bottom edge of the paint coated swatch on the swatch layer immediately below thereby showing an area of the paint coated swatch on the intermediate and bottom swatch layers, the release composition and indirect adhesive being printed such that each of the paint coated swatches have a top edge which is above the top edge of the paint coated swatch on the swatch layer immediately below.

8. A method for making a color display device, the method comprising:
printing a release composition on a paper base which comprises an 80 pound cover paper both sides of which have been calendared;
printing an indirect adhesive the printed release composition on the paper base;
applying a paint coated swatch to the printed indirect adhesive to provide a paint coated swatch layer;
cutting the paint coated swatch layers having a top and side edges so that each layer has a different size;
collating the paint coated swatch layers on a conveyor which moves the swatch layers from an upstream to a downstream direction to provide collated stacks of swatch layers; and
aligning the top and side edges of the collated stacks of swatch layers by transporting the collated stacks of swatch layers to a vibrating table which is upwardly inclined from the downstream to the upstream direction, the table having a surface which is tilted such that the top edges of the stacks engage a stop, the table also having pushers which engage the upstream side edges of the stacks to provide stacks of collated paint coated swatch layers having top and side edges which are aligned; and
binding the stacks of collated paint coated swatch layers with aligned edges to provide a color display device, the color display device having a plurality of paint coated color swatches layers each having a different size, the layers in stacked relation, a top layer partially overlapping a first immediate layer below the top layer, the first intermediate layer overlapping a second intermediate layer below the first intermediate layer, and a bottom layer each swatch layer having a bottom edge offset and above the layer immediately below so that each of the layers do not completely cover the swatch layer below permitting a viewer to view paint on each of the swatch layers, the plurality of swatch layers joined at one end to permit the swatch layers to be lifted above and away from the intermediate layer immediately below, the swatch layers being joined so that the top and intermediate layers may be lifted so that the entire swatch layer below the swatch being lifted may be viewed,
each of the swatch layers including the base paper layer, the printed release composition layer, the printed pressure sensitive indirect adhesive layer and the removable paint coated swatch, the removable paint coated swatch being releasably mounted on the pressure sensitive indirect adhesive, the pressure sensitive adhesive bonding to the paint coated swatch to the swatch layer and effective for providing a releasably bonded paint coated color swatch which may be repositioned remote from the color display device and releasably bonded onto a remote substrate
